(19) United States
(12) Patent Application Publication
(10) Pub. No.: US 2013/0027182 A1
(43) Pub. Date: Jan. 31, 2013

(54) Electronic locking device having a concealed notification function and the notification method thereof

(71) Applicants: Ching-Paio CHIANG, Hsinchu City (TW); Tsung-Min Yeh, Zhubei City (TW)

(72) Inventors: Ching-Paio CHIANG, Hsinchu City (TW); Tsung-Min Yeh, Zhubei City (TW)

(21) Appl. No.: 13/421,999

(22) Filed: Mar. 16, 2012

(30) Foreign Application Priority Data
Jul. 26, 2011 (TW) 100126341

(51) Int. Cl. G08B 29/00

(52) U.S. Cl. 340/5.54

(57) ABSTRACT

An electronic locking device having a concealed notification function comprises an input module, an identification module connected to the input module, a lock-fastening module connected to the identification module, and a notifying module connected to the identification module, wherein the electronic locking device is characterized in that: the notifying module performs a notifying process according to a control signal output by the identification module, and at least one recipient end is notified by the notifying process and each recipient end is notified at least once to enhance the security function of the electronic locking device.

The current application claims a foreign priority to a patent application in Taiwan with a serial number 100126341 filed on Jul. 26, 2011.

### BACKGROUND OF THE INVENTION

1. Field of the Invention

The present invention is related to a security system and the security process thereof, and more particularly, to a security system and its security process provided in an electronic locking device, whereby when a password entered is identified as the password for emergency mode, a setup signal is output to at least one recipient end for initiating emergency procedures; with the security system and the security process, defects of conventional mechanical locks or electronic locking devices with regard to safety maintenance can be effectively reinforced, protection of personal and property safety can be further enhanced, and public order can be better safeguarded.

2. Description of the Prior Art

During recent years, criminal events such as burglary and theft have frequently occurred and almost become unpreventable. At the same time, the contemporary society has also placed greater emphasis on residential security, personal safety, and property protection. Security and access control demands have gradually increased, and people take care in choosing gate and door locks. To discourage unwanted visitors, nowadays people often install multiple sets of locks in their dwellings to ensure residential security.

Conventional door locks include mechanical locking devices and electronic locking devices, which are distinctly different in terms of usage and described in detail as follows:

Practically speaking, thieves can easily break conventional mechanical locking devices using hand tools and then enter dwellings to conduct thefts. Moreover, conventional mechanical locking devices are not equipped with immediate warning or deterring function, so that it becomes easy for thieves to break in and steal. Therefore, at present high-security electronic locking devices (or digital locking devices) are widely used to substitute conventional mechanical locking devices. One main reason is that once a password is set up for the electronic locking device, only the user knows this password, and the anti-theft function is thus enhanced. However, as new ways to commit crimes are continually developed, some culprits start to follow the user into the building and force the user to unlock the mechanical or electronic locking device(s); threatened by culprits, the user thus unlocks the mechanical or electronic locking device(s), and these locking devices thus lose their anti-theft function not matter how elaborate they are.

To compensate for the deficiency of mechanical and electronic locking devices as described above, the present invention mainly provides an electronic locking device having security function and the security process thereof, whereby when a password entered is identified as signaling an emergency, a setup signal is output to at least one recipient end for initiating emergency procedures.

### SUMMARY OF THE INVENTION

In order to solve the problem mentioned above, one objective of the present invention is to provide a security system that can be implemented in an electronic locking device; the security system comprises: an input module, an identification module, a lock-fastening module, and a notifying module, whereby when a password entered is identified as signaling an emergency, a setup signal is output by the notifying module to a recipient end for initiating emergency procedures; with the security system, protection of personal and property safety can be enhanced, and more particularly, personal safety of females arriving home at nighttime, and social order overall can also be further enhanced.

Another objective of the present invention is to provide a notification method, whereby when a password entered is identified as signaling an emergency, a setup signal is output by the notifying module to a recipient end for initiating emergency procedures; with the addition of the emergency mechanism, protection of personal and property safety can thus be effectively enhanced.

Still another objective of the present invention is to provide a notifying process, whereby when a password entered is identified as signaling an emergency, a setup signal is output according to the notifying process by the notifying module to a recipient end for notifying several different recipient ends and notifying each recipient end more than once, protection of personal and property safety thus being further strengthened.

According to the aforementioned objectives, the present invention first provides an electronic locking device having a security system, which comprises an input module, an identification module connected to the input module, a lock-fastening module connected to the identification module, and a notifying module connected to the identification module, wherein the electronic locking device is characterized in that: the notifying module performs a notifying process according to a control signal output by the identification module, and at least one recipient end is notified by the notifying process and each recipient end is notified at least once.

The present invention then provides an electronic locking device having a security system, which comprises: an input module for the user to enter a password; an identification module connected to the input module and provided with a security process, wherein at least a password for security mode and a password for emergency mode are set up in the security process for the security process to match the password entered with the password for security mode and the password for emergency mode for identification and outputs at least a first control signal or a first control signal and a second control signal after the identification is completed; a lock-fastening module, connected to the identification module and performing the task of unlocking according to the first control signal output by the identification module; a notifying module, connected to the identification module and provided with a notifying process, which performs the notifying process according to the second control signal output by the identification module; wherein, when the identification module identifies the password entered as the same as the password for security mode, the identification module outputs a first control signal for the lock-fastening module to perform the task of unlocking, and when the identification module identifies that the password entered is the same as the password for emergency mode, the identification module outputs a first control signal for the lock-fastening module to perform the task of unlocking and also a second control signal to perform a notifying process.

The present invention further provides a security process, a notification method formed by which is provided in an electronic locking device having a security system, the electronic locking device comprising an input module, an identification module connected to the input module, a lock-fastening module connected to the identification module, and a notifying module connected to the identification module, wherein the security process of the electronic locking device comprises: entering a password, wherein the user enters a password via the input module; identifying the password, wherein at least a password for security mode and a password for emergency mode are set up in the identification module, and the security process matches the password entered with the password for security mode and the password for emergency mode for identification and outputs at least a first control signal or a first control signal and a second control signal after the identification is completed; outputting a first control signal for the lock-fastening module to perform the task of unlocking when the identification module identifies the password entered as the same as the password for security mode; outputting a first control signal for the lock-fastening module to perform the task of unlocking and also a second control signal when the identification module identifies the password entered as the same as the password for emergency mode, and the notifying module performing a notifying process after receiving the second control signal.

The present invention then provides a notifying process provided in an electronic locking device, the electronic locking device comprising an input module, an identification module connected to the input module, a lock-fastening module connected to the identification module, and a notifying module connected to the identification module, wherein the notifying process of the electronic locking device comprises: entering a password, wherein the user enters a password via the input module; identifying the password, wherein at least a password for security mode and a password for emergency mode are set up in the identification module, and the security process matches the password entered with the password for security mode and the password for emergency mode for identification and outputs at least a first control signal or a first control signal and a second control signal after the identification is completed; outputting a first control signal for the lock-fastening module to perform the task of unlocking when the identification module identifies the password entered as the same as the password for security mode; outputting a first control signal for the lock-fastening module to perform the task of unlocking and also a second control signal when the identification module identifies the password entered as the same as the password for emergency mode, and the notifying module performing a notifying process after receiving the second control signal.

With the electronic locking device having a security system, security process, and notifying process provided by the present invention, personal and property safety can be effectively protected and social order overall can be further enhanced and maintained.

### BRIEF DESCRIPTION OF THE DRAWINGS

FIG. 1 is a function block diagram of the electronic locking device of the present invention having a concealed notification function;

FIG. 2 is a diagram of an embodiment of the security process of the electronic locking device of the present invention having a concealed notification function;

FIG. 3 is a diagram of the notifying process of the security process of the present invention; and

FIG. 4 is a diagram of another embodiment of the security process of the electronic locking device of the present invention having a concealed notification function.

### DETAILED DESCRIPTION OF THE PREFERRED EMBODIMENT

The present invention mainly discloses a security system 1 provided in an electronic locking device and a security process 2, wherein basic structure and functions of electronic locking device is already known to those skilled in the art and description of which is therefore omitted in the following for the description as follows to be focused on the security system 1 of the present invention as provided in a conventional electronic locking device. The present invention is primarily characterized in disclosing a security system 1 provided in an electronic locking device and design of a security process 2. Moreover, what is to be clarified in advance is that, diagrams referred to in the following description are only to illustrate structure related to characteristics of the present invention and are not made according to actual scale.

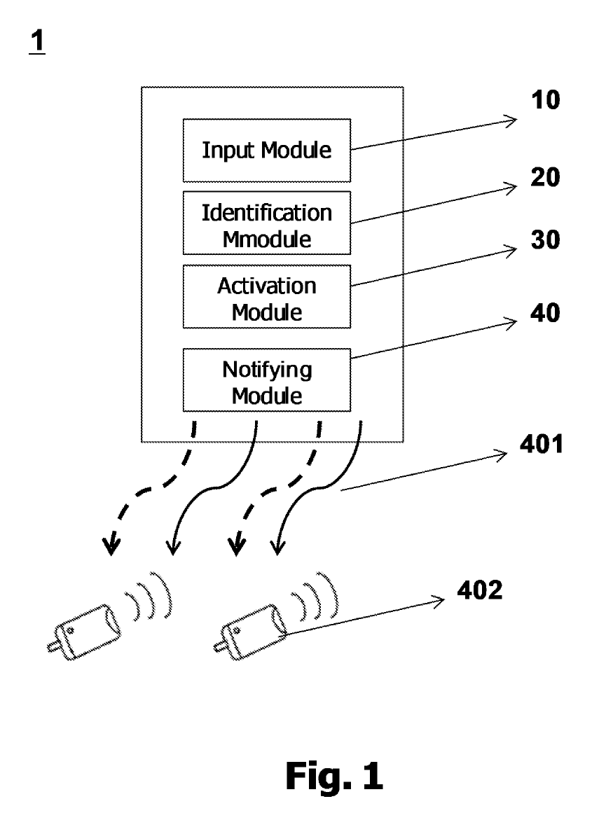

Referring to FIG. 1, which is a function block diagram of the electronic locking device of the present invention having a security system. The electronic locking device of the present invention having a concealed notification function is formed by providing an electronic locking device with a security system 1. The electronic locking device of the present invention comprises: an input module 10, provided for the user to enter a password 101, wherein the password 101 entered is a string of Arabic numerals, English letters, or any identifiable symbols; in the embodiment of the present invention, the input module 10 can be a numeric keypad or a touch panel with which numbers can be entered. An identification module 20, which is connected to the input module 10 and provided with a security process 2 that is provided for identifying the password 101 entered and outputting at least a control signal according to the identification result; in the embodiment of the present invention, the identification module 20 can be a control chip, wherein the control chip is provided with a security process 2, in which at least two passwords are set up, one password being password for security mode 102 and the other being password for emergency mode 103, and therefore the control chip determines whether the password 101 entered by the user is the password for security mode 102 or the password for emergency mode 103; the control chip then outputs at least a control signal according to the result of determining and identifying the password entered. A lock-fastening module 30, which is connected to the identification module 20, can be mounted on the door board, and performs the task of unlocking or locking according to the control signal output by the identification module 20; in the embodiment of the present invention, when the control chip determines that the password entered is the same as the password for security mode 102, it outputs a control signal for unlocking to the lock-fastening module 30 for the task of unlocking to be performed and the door is opened for user to enter; or when the control chip determines that the password entered is the same as the password for emergency mode 103, it outputs a control signal for unlocking to the lock-fastening module 30 for the task of unlocking to be performed and the door is opened for user to enter; or when the control chip determines that the password entered is incorrect, it selects not to output any control signal for the lock-fastening module 30 to remain locked and the door cannot be opened. And a notifying module 40, which is connected to the identification module 20 and performs a notifying process 3 according to the identification result of the identification module 20; for example, when the control chip determines that the password 101 entered is the password for emergency mode 103, it outputs a control signal for unlocking to the lock-fastening module 30 for the task of unlocking to be performed for the door to open for the user to enter and outputs another control signal to the notifying module 40 for a notifying process 3 to be performed; or when the control chip determines that the password 101 entered is an incorrect one (i.e. neither the password for security mode 102 nor the password for emergency mode 103), the lock-fastening module 30 remains locked, and a control signal is output to the notifying module 40 for a notifying process 3 to be performed.

In the embodiment of the present invention, a security process 2 is provided and saved in the identification module 20; for example, the security process 2 is provided and saved in the control chip; when the control chip determines that the password 101 entered is the password for emergency mode 103, it outputs a control signal to the lock-fastening module 30 and outputs another control signal to the notifying module 40 for a setup notifying process 3 to be performed; wherein, the notifying module 40 can be a subscriber identity model module (SIM module) or a Global System for Mobile Communications module (GSM module); for example, the notifying process 3 provided in the memory unit of the SIM module or the GSM module is performed to call guard(s) or related persons; wherein, the notifying process 3 will be described in the following. However, the notifying module 40 of the present invention is not limited to the SIM module; for example: when the notifying module 40 receives the control signal output by the identification module 20, the notifying module 40 activates a setup output signal 401, which can call the setup recipient end 402 via wireless or wired transmission. Moreover, the notifying module 40 can also be set up in a control server of the security system already owned by the user; therefore, a control signal can be output via the already available security system to inform guard(s) that there is an emergency where the user is located and immediate rescue is needed.

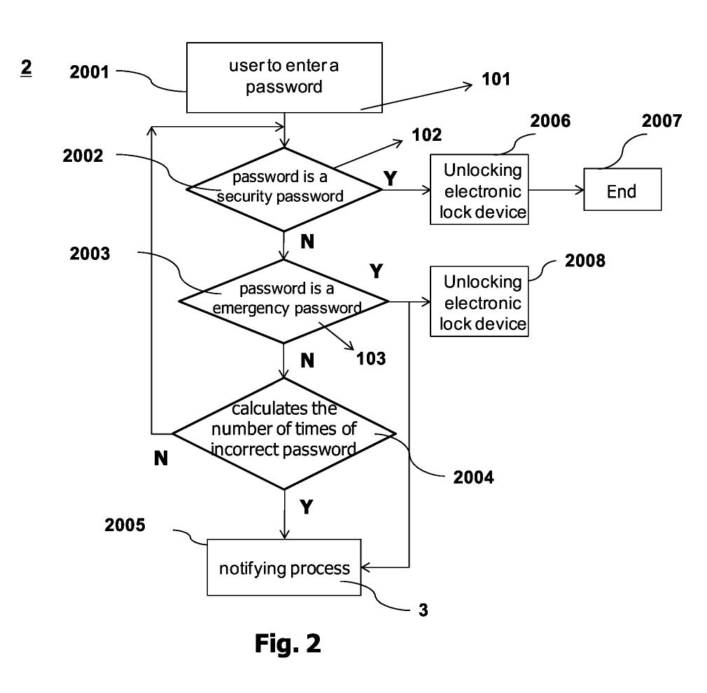

Then, referring to FIG. 2, which is a diagram of an embodiment of the security process of the electronic locking device of the present invention having a security system. As described above, the electronic locking device of the present invention having a concealed notification function is formed by providing an electronic locking device with a security system 1. Apparently, in the present embodiment, the notification method formed by the security process 2 is provided in the identification module 20 of the electronic locking device, so that the identification module 20 is able to identify the password entered via the input module 10 and to output at least a control signal to the lock-fastening module 30 and/or the notifying module 40 according to the identification result, detailed procedures of which are described in the following.

As shown in FIG. 2, the notification method formed by the security process 2 of the present embodiment comprises: step 2001: the user enters via the input module 10 a password 101 consisting of a plurality of Arabic numerals, English letters, or any identifiable symbols; then follows step 2002, if the password 101 entered is the same as the setup password for security mode 102, the security process in the identification module 20 is provided to identify the password 101 entered as the password of the safety 102 and the identification module 20 outputs a control signal; and then follows step 2006, the control signal output by the identification module 20 is received by the lock-fastening module 30, and the lock-fastening module 30 outputs a signal for unlocking the electronic lock device; finally, the process ends, as shown in step 2007.

Moreover, as shown in FIG. 2, when the password 101 entered by the user in step 2001 is identified as the password for emergency mode 103, then follows step 2002, the security process 2 provided in the identification module 20 identifies that the password entered (i.e., the password for emergency mode 103) is different from the setup password for security mode 102; then follows step 2003; in step 2003, if the password 101 entered is the setup password for emergency mode 103, the security process 2 provided in the identification module 20 is able to identify the password entered as the same as the setup password for emergency mode 103, and the identification module 20 will or respectively output a first control signal and a second control signal; then follows step 2008; upon receiving the first control signal output by the identification module 20, the lock-fastening module 30 unlocks the electronic locking device; meantime, the second control signal output by the identification module 20 is also received by the notifying module 40 for a setup notifying process 3 to be performed, as shown in step 2005. As step 2005 informs related parties or persons according to the setup notifying process 3, the notified parties or persons are informed by the notifying process 3 that the user is currently in danger and have to immediately proceed to the location where the user is to carry out further action. Apparently, in the embodiment of the present invention, when the user is under a specific situation, being forced by culprit(s) to unlock the electronic locking device for example, the user enters the setup password for emergency mode 103 via the input module 10, and the identification module 20 identifies the password entered as the password for emergency mode 103 and thus outputs a first control signal for the lock-fastening module 30 to unlock the electronic locking device and also a second control signal to activate the notifying module 40 for a setup notifying process 3 to be performed for notifying related parties or persons for immediate rescue. Wherein, culprit(s) are not able to know the setup password for security mode 102 and the password for emergency mode 103, and no matter the user enters the password for security mode 102 or the password for emergency mode 103 via the input module 10, the electronic locking device of the present invention will be unlocked the user will be not be harmed by culprit(s); therefore, when the user enters the setup password for emergency mode 103, the culprit(s) will not know that the electronic locking device of the present invention is activated and the notifying process 3 is performed. Thus, the electronic locking device of the present invention is able to protect personal safety of the user without arousing the suspicion of culprit(s).

And then, when a third person, i.e. a person other than the one who sets up the electronic locking device, enters an incorrect password via the input module 10 (neither the setup password for security mode 102 nor the setup password for emergency mode 103), since this third person does not know the setup password for security mode 102 or password for emergency mode 103 set up for the electronic locking device, then follows step 2001 after this third person enters an incorrect password via the input module 10; then follows step 2002, wherein the security process provided in the identification module 20 identifies the incorrect password entered as different from the setup password for security mode 102; then follows step 2003; in step 2003, if the incorrect password entered is also identified as different from the setup password for emergency mode 103, then follows step 2004; in step 2004, the identification module 20 calculates the number of times an incorrect password is entered and matches this number with a setup number of times, when the number of times an incorrect password is entered is different from the setup number of times, the electronic locking device remains at normal status; if the third person enters different incorrect passwords via the input module 10 for multiple times, then when the number of times an incorrect password is entered reaches the setup number of times, 4 times for example, namely, an incorrect password being entered 4 times, the identification module 20 of the present embodiment controls the lock-fastening module 30 to remain at original locking status and outputs a third control signal to the notifying module 40 for a notifying process 3 to be performed, and thus the notifying module 40 performs the setup notifying process 3 as described above, as shown in step 2005. As step 2005 calls related parties or persons according to the setup notifying process 3, the notified parties or persons are informed by the notifying process 3 that the user is currently in danger and have to immediately proceed to the location where the user is to carry out further action. Apparently, the notifying process 3 of the present embodiment of the electronic locking device of the present invention can be activated and performed without arousing the suspicion of culprit(s) and thus functions to prevent break-in and ensure residential security.

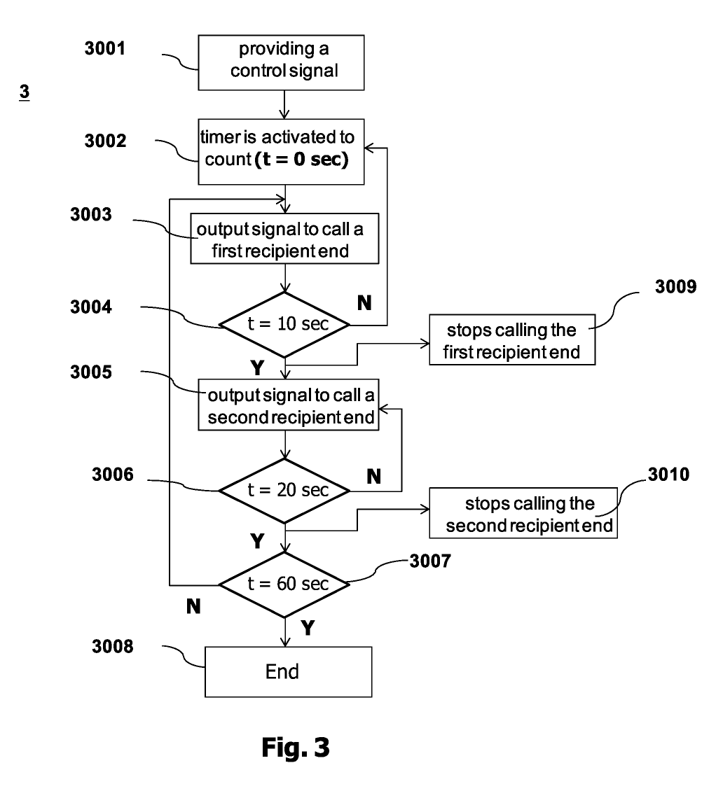

Referring then to FIG. 3, which is a diagram of the notifying process in the security process of the present invention. As shown in FIG. 3, the notifying process 3 of the present invention comprises: providing a control signal to activate the notifying process 3, wherein the control signal is a second control signal or a third control signal provided by the identification module 20 according to the setup of the security process 2 and to the identification result of the password 101 entered by the user with the password for security mode 102 and password for emergency mode 103 set up in the security process 2, as shown in step 3001. Then, after the control signal provided by the identification module 20 is received, a timer is activated to count (t=0 sec), as shown in step 3002. Then, an output signal 401 is output by the notifying module 40 to call a first recipient end, as shown in step 3003; the output signal 401 here can be output via wired or wireless transmission to the first recipient end; for example, the notifying module 40 is connected to an emergency apparatus in the guardroom in the place where the user is located via a conducting wire, and when the emergency apparatus receives an output signal 401 output by the notifying module 40, the alarm ring is activated and the location of the user is indicated to inform guard(s) or related persons that there is an emergency where the user is located and immediate rescue is needed. For another example: the notifying module 40 is connected to a control server of security system already owned by the user, and therefore a warning signal can be output via the already available security system to inform guard(s) or related persons that there is an emergency where the user is located and immediate action needs to be taken. For still another example, the notifying module 40 can also be connected to an emergency apparatus in the guardroom in the place where the user is located via other routes (such as telephone or computer network connected by electric wires, cables, or fiber cables) or a wireless communications system (such as Bluetooth system or wireless network), and when the emergency apparatus receives an output signal 401 output by the notifying module 40, the alarm ring is activated and the location of the user is indicated to inform guard(s) that there is an emergency where the user is located and immediate rescue is needed. For yet another example, the notifying module 40 can be a SIM module or a GSM module: according to the setup of the SIM module or the GSM module, a dialing task is automatically performed to call the first recipient end (mobile phone for example); when the first recipient end receives the output signal 401 output by the notifying module 40, there will be buzzing and warning messages such as “the user has an emergency” to inform and urge the first recipient end to immediately proceed to where the user is for further action. In the present embodiment, the way in which the notifying module 40 outputs the output signal 401 is not limited, and the function achieved in the present invention is to inform the first recipient end; moreover, the way of indication on the first recipient end is not limited either, which can be achieved by using textual signal(s), voice signal(s), flash signal(s), color signal(s) or combination of any of the above or text message(s); furthermore, the first recipient end is not limited in the present invention and can be a police station, a fire station, or any individual or group set up to be able to receive the output signal 401. What is to be emphasized here is that, the notifying module 40 of the present invention is not limited to the embodiments disclosed and described above; any apparatus that transmits the second control signal or the third control signal provided by the identification module 20 to the recipient end is an embodiment of the notifying module 40 of the present invention.

Then follows step 3004: the first timer counts and determines whether a second setup time (10 seconds for example) is reached, namely, during the 10-second span, the notifying module 40 incessantly outputs the output signal 401 to the first recipient end; when the first timer counts till the 10th second since the output signal 401 is output, the notifying module 40 immediately stops notifying the first recipient end, as shown in step 3009; meantime, when the first timer counts and determines that 10 seconds is reached after the output of the output signal 401, the notifying module 40 continues to output the output signal 401 to a second recipient end, as shown in step 3005; what is to be emphasized here is that, the transmitting method for notifying the second recipient end, the indication method on the second recipient end, and the individual or group on the second recipient end are the same as those for notifying or on the first recipient end and the description of which is thus omitted here.

And then follows step 3006: the first timer counts and determines whether the second setup time (10 seconds for example) is reached, namely, during the 10-second span, the notifying module 40 incessantly outputs the output signal 401 to the second recipient end; when the second timer counts and determines that 10 seconds is reached after the output of the output signal 401, the notifying module 40 immediately stops notifying the second recipient end, as shown in step 3010.

Then follows step 3007: the second timer counts and determines whether the third setup time (60 seconds for example) is reached, wherein when the timer determines that 60 seconds is not yet reached, the notifying process 3 goes back to step 3003 and re-starts incessantly outputting output signal 401 to the first recipient end till the first timer counts and determines that 10 seconds is reached after the output of the output signal 401 to the first recipient end, as shown in step 3004; the notifying module 40 immediately stops notifying the first recipient end, as shown in step 3009; meantime, when the first timer determines that 30 seconds is reached after the output of the output signal 401, step 3005 of the notifying process 3 is repeated for the output signal 401 to be output to the second recipient end; when the notifying module 40 incessantly outputs the output signal 401 to the second recipient end, and the first timer determines that 40 seconds is reached after the output of the output signal 401, the notifying module 40 immediately stops notifying the second recipient end, as shown in step 3010. And when the second timer determines that 60 seconds is not yet reached, as shown in step 3007, the notifying process 3 performs again the aforementioned procedure till the second timer determines that 60 seconds is reached, and then the notifying process 3 is stopped, as shown in step 3008. What is to be further clarified is that, the first timer and the second timer are here differentiated only to facilitate the description; in a preferred embodiment, the electronic locking device or the control chip of the present invention is disposed with only one timer, and time can be counted and determined by the control chip.

Apparently, one of the major technical characteristics of the present invention is that, with the electronic locking device and the notification method formed by the security process 2 provided by the present invention, the electronic locking device is equipped with the function to automatically inform the recipient end when the user is threatened or forced by culprit(s) to unlock the locking device without arousing the suspicion of culprit(s); and in order to ensure that the recipient end can be effectively and successfully informed, the notifying process 3 in the notification method provided by the present invention informs a plurality of recipient ends and each recipient end is not just informed more than once but also incessantly notified, whereby protection of personal and property safety of the user is further secured and enhanced.

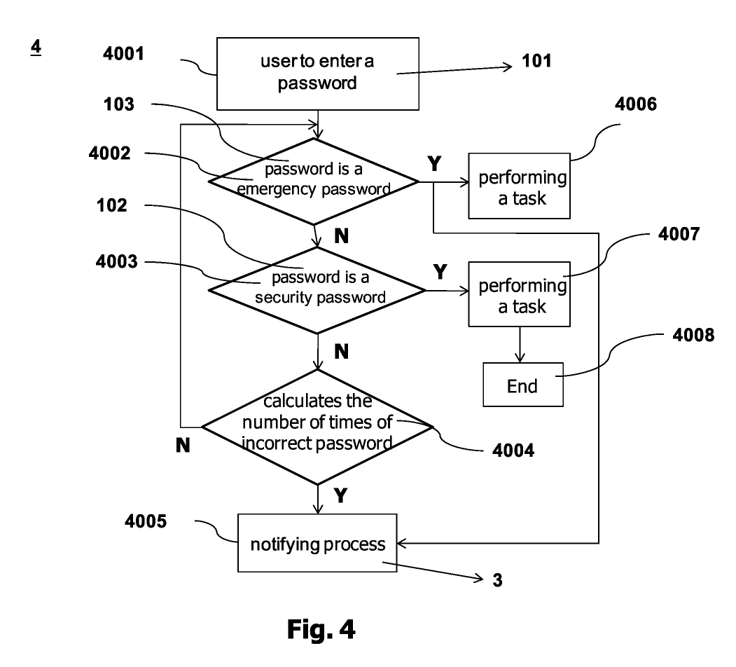

Referring then to FIG. 4, which is a diagram of another embodiment of the security process of the electronic locking device of the present invention having a security system. First, as described above, the electronic locking device of the present invention having a concealed notification function is formed by providing an electronic locking device with a security system 1. Apparently, in the present embodiment, the notification method formed by the security process 2 is provided in the identification module 20 of the electronic locking device, so that the identification module 20 can identify the password entered via the input module 10 and output at least a control signal to the lock-fastening module 30 and/or the notifying module 40 according to the identification result of the password entered, detailed process of which is described as follows.

Then, referring to FIG. 4, in which is the notification method formed by the security process 2 of the present embodiment, which comprises: step 4001, wherein the user enters via the input module 10 a password 101 consisting of a plurality of Arabic numerals, English letters, or any identifiable symbols; then follows step 4002, wherein the security process 2 provided in the identification module 20 identifies whether the password 101 entered is the same as the password for emergency mode 103; when the password 101 entered is the same as the password for emergency mode 103, the identification module 20 or respectively outputs a first control signal and a second control signal; then follows step 4006, upon receiving the first control signal output by the identification module 20, the lock-fastening module 30 immediately outputs a signal for unlocking the electronic locking device; meantime, the notifying module 40 receives the second control signal output by the identification module 20 and performs a setup notifying process 3, as shown in step 4005. When the setup notifying process 3 shown in FIG. 3 notifies related parties or persons in step 4005, these related parties or persons are informed that the user is currently in danger and have to immediately proceed to the location where the user is for further action. Apparently, in the embodiment of the present invention, when the user is under a specific situation, being forced by culprit(s) to unlock the lock for example, the user enters via the input module 10 the setup password for emergency mode 103, which is thus identified by the identification module 20 as the setup password for emergency mode 103, the identification module 20 not only outputs a first control signal for the lock-fastening module 30 to unlock the electronic locking device, but also outputs a second control signal to activate the notifying module 40 for performing a setup notifying process 3 to inform the recipient end of the user's need for immediate rescue. Since culprit(s) know neither the password for security mode 102 nor the password for emergency mode 103 set up by the user, and no matter the password entered via the input module 10 is password for security mode 102 or password for emergency mode 103, the electronic locking device will be unlocked, culprit(s) will not become suspicious and will not harm the user; therefore, the user is able to enter the setup password for emergency mode 103 and activate and perform the notifying process 3 of the present invention without being discovered by culprit(s). Therefore, the electronic locking device of the present invention is able to protect personal safety of the user without arousing the suspicion of culprit(s).

If the password 101 entered by the user in step 4001 is the same as the password for security mode 102, step 4002 then follows, wherein the security process provided in the identification module 20 identifies that the password for security mode 102 entered is different from the setup password of emergency 103; then follows step 4003; in step 4003, if the password 101 entered is the same as the setup password for security mode 102, the identification module 20 outputs a control signal; then follows step 4007, wherein upon receiving a control signal from the identification module 20, the lock-fastening module 30 outputs a signal to unlock the electronic locking device; finally, the process ends, as shown in step 4008.

And then, when a third person, i.e. a person other than the one who sets up the electronic locking device, enters an incorrect password via the input module 10 (neither the setup password for security mode 102 nor the setup password for emergency mode 103), since this third person knows neither the setup password for security mode 102 nor password for emergency mode 103 set up in the automated notification apparatus, then follows step 4001 after this third person enters an incorrect password via the input module 10; then follows step 4002, wherein the security process 2 provided in the identification module 20 identifies the incorrect password entered as different from the setup password for emergency mode 103; then follows step 4003; in step 4003, if the incorrect password entered is also identified as different from the setup password for security mode 102, then follows step 4004; in step 4004, the identification module 20 calculates the number of times an incorrect password is entered and matches this number with a setup number of times, when the number of times an incorrect password is entered is different from the setup number of times, the electronic locking device remains at normal status; if the third person enters different incorrect passwords via the input module 10 for multiple times, then when the number of times an incorrect password is entered reaches the setup number of times, 4 times for example, namely, an incorrect password being entered 4 times, the identification module 20 of the present embodiment controls the lock-fastening module 30 to maintain the status of being locked and outputs a third control signal to the notifying module 40 for a notifying process 3 to be performed, and thus the notifying module 40 performs the setup notifying process 3 as described above, as shown in step 4005. As step 4005 notifies related parties or persons according to the setup notifying process 3, the notified parties or persons are informed by the notifying process 3 that the user is currently in danger and have to immediately proceed to the location where the user is to carry out further action. Apparently, the electronic locking device of the present invention can prevent burglaries; with the notifying process 3 of the present embodiment, the electronic locking device will be activated and the notifying process 3 will be performed without arousing the suspicion of culprit(s) and to protect dwelling and property safety of the user. In addition, what is to be emphasized is that, in the present embodiment, the notifying process 3 is the same as that shown in FIG. 3 and the description of which is thus omitted.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An electronic locking device having a concealed notification function, said electronic locking device comprising:
an input module, provided for the user to enter a password;
an identification module, connected to said input module, a security process being provided in said identification module and at least a password for security mode and a password for emergency mode being set up in said security process, said security process matching said password entered with said password for security mode and said password for emergency mode for identification and outputting at least a first control signal or a first control signal and a second control signal after completing identification;
a lock-fastening module, connected to said identification module, said lock-fastening module performing task of unlocking according to said first control signal output by said identification module; and
a notifying module, connected to said identification module, a notifying process being provided in said notifying module, said notifying module performing said notifying process according to said second control signal output by said identification module; wherein,
when said identification module identifies said password entered as the same as said password for security mode, said identification module outputs said first control signal for said lock-fastening module to perform task of unlocking;
when said identification module identifies said password entered as the same as said password for emergency mode, said identification module outputs said first control signal for said lock-fastening module to perform task of unlocking and also said second control signal for said notifying process to be performed.

2. The electronic locking device according to claim 1, wherein said input module is a numeric keypad or a touch panel with which passwords can be entered.

3. The electronic locking device according to claim 1, wherein when said identification module identifies said password entered as different from said password for security mode and from said password for emergency mode, said identification module further outputs a third control signal, and said notifying module performs said notifying process upon receiving said third control signal.

4. The electronic locking device according to claim 1, wherein said notifying process notifies at least one recipient end, and each said recipient end is notified at least once.

5. The electronic locking device according to claim 3, wherein said notifying process notifies at least one recipient end, and each said recipient end is notified at least once.

6. The electronic locking device according to claim 1, wherein said notifying module is selected from the group consisting of: subscriber identity model module (SIM module), Global System for Mobile Communications module (GSM module), wired communications modules, and wireless communications modules.

7. The electronic locking device according to claim 3, wherein said wherein said notifying module is selected from the group consisting of: subscriber identity model module (SIM module), Global System for Mobile Communications module (GSM module), wired communications modules, and wireless communications modules

8. A security process of an electronic locking device, said security process being provided in an electronic locking device with a security system, said electronic locking device comprising an input module, an identification module connected to said input module, a lock-fastening module connected to said identification module, and a notifying module connected to said identification module, wherein said security process of said electronic locking device comprises:
entering a password, said password being entered by the user via said input module;
identifying said password entered, at least a password for security mode and a password for emergency mode being set up in said identification module, said security process matching said password entered with said password for security mode and said password for emergency mode for identification and outputting at least a first control signal or a first control signal and a second control signal after completing identification; wherein,
when said identification module identifies said password entered as the same as said password for security mode, said identification module outputs said first control signal for said lock-fastening module to perform task of unlocking;
when said identification module identifies said password entered as the same as said password for emergency mode, said identification module outputs said first control signal for said lock-fastening module to perform task of unlocking and also said second control signal to said notifying module, said notifying module performing a notifying process upon receiving said second control signal.

9. The security process according to claim 8, wherein when said identification module identifies said password entered as different from said password for security mode and from said password for emergency mode, said identification module further outputs a third control signal, and said notifying module performs said notifying process upon receiving said third control signal.

10. The security process according to claim 8, wherein said notifying process comprises:
a. activating said notifying process, and a timer starting to count (t=0 sec);
b. notifying a first recipient end, said first recipient end being notified by output signal output by said notifying module;
c. determining whether said timer counts to a first setup time, notifying of said first recipient end continuing when said first setup time is not yet reached, and notifying of said first recipient end being stopped and said notifying module outputting output signal to call a second recipient end when said first setup time is reached;
d. determining whether said timer counts to a second setup time, notifying of said second recipient end continuing when said second setup time is not yet reached, and notifying of said second recipient end being stopped when said second setup time is reached;
e. determining whether said timer counts to a third setup time, performing steps b˜d continuously when said third setup time is not yet reached.

11. The security process according to claim 8, wherein said notifying module is selected from the group consisting of: subscriber identity model module (SIM module), Global System for Mobile Communications module (GSM module), wired communications modules, and wireless communications modules.

12. An electronic locking device having a concealed notification function, said electronic locking device comprising an input module, an identification module connected to said input module, a lock-fastening module connected to said identification module, and a notifying module connected to said identification module, wherein said electronic locking device is characterized in that:
said notifying module performs a notifying process according to a control signal output by said identification module, and said notifying process notifies at least one recipient end and each said recipient end is notified at least once.

13. The electronic locking device according to claim 12, wherein said input module is a numeric keypad or a touch panel with which numbers can be entered.

14. The electronic locking device according to claim 12, wherein when said identification module identifies said password entered as different from said password for security mode and from said password for emergency mode, said identification module further outputs a third control signal, and said notifying module performs said notifying process upon receiving said third control signal.

15. A notifying process provided in an electronic locking device, said electronic locking device comprising an input module, an identification module connected to said input module, a lock-fastening module connected to said identification module, and a notifying module connected to said identification module, wherein said notifying process of said electronic locking device comprises:
entering a password, said password being entered by the user via said input module;
identifying said password entered, at least a password for security mode and a password for emergency mode being set up in said identification module, said security process matching said password entered with said password for security mode and said password for emergency mode for identification and outputting at least a first control signal or a first control signal and a second control signal after completing identification; wherein,
when said identification module identifies said password entered as the same as said password for security mode, said identification module outputs said first control signal for said lock-fastening module to perform task of unlocking;
when said identification module identifies said password entered as the same as said password for emergency mode, said identification module outputs said first control signal for said lock-fastening module to perform task of unlocking and also said second control signal to said notifying module, said notifying module performing a notifying process upon receiving said second control signal.

16. The notifying process according to claim 15, wherein said notifying module is selected from the group consisting of: subscriber identity model module (SIM module), Global System for Mobile Communications module (GSM module), wired communications modules, and wireless communications modules.
